(19) United States
(12) Patent Application Publication
(10) Pub. No.: US 2002/0018982 A1
(43) Pub. Date: Feb. 14, 2002

(54) Dynamometer racing simulator

(76) Inventor: Steven J. Conroy, Sykesville, MD (US)

Correspondence Address: ROYAL W. CRAIG, A PROFESSIONAL CORPORATION, SUITE 1319, 210 NORTH CHARLES STREET, BALTIMORE, MD, 21201, US

(21) Appl. No.: 09/853,493

(22) Filed: May 11, 2001

Related U.S. Application Data
(60) Provisional application No. 60/203,882, filed on May 12, 2000.

(51) Int. Cl. G09B 9/04; G09B 19/16

(52) U.S. Cl. 434/62

(57) ABSTRACT

A system for computer dynamometer testing while running an auto racing simulation. The combination increases the entertainment value of testing through a real-time interactive racing simulation. The system includes a vehicle testing station such as a conventional chassis dynamometer with digital feedback and load control for automatically increasing or decreasing the load applied to the vehicle wheels under test, a programmable test controller connected to the digital feedback unit for collecting data, and also connected to the load control assembly for controlling the dynamic load applied to the wheels of the vehicle. In addition, a simulation computer is connected to the programmable test controller and includes diagnostic software for analyzing said data, simulation software for running a synchronized race simulation based on the data, and report generation software for generating the diagnostic report based on the analyzed data. The race simulation is displayed to the driver of the test vehicle on a video display suspended immediately in front. Test data is collected during the simulation and is analyzed to ascertain the engine performance of the test vehicle. Given a proper analysis, a comprehensive driver performance report based on the test data is printed so that the driver can evaluate repair/performance enhancement scenarios. The repair/performance enhancement scenarios are correlated to a database of sponsor/advertiser profiles, and in each report a recommended sponsor is identified to provide the necessary goods and services. The system helps to standardizes and guide the dynamometer sampling to determine existing conditions, and automates the data collection and analysis phase, generating a comprehensive report outlining appropriate performance enhancement/repair scenarios for the customer.

### CROSS-REFERENCE TO RELATED APPLICATIONS

The present application derives priority from U.S. Provisional Patent Application No. 60/203,882; Filed: May 12, 2000.

### BACKGROUND OF THE INVENTION

1. Field of the invention

The present invention relates to a system and method for providing a realistic drag racing simulation experience inside the family car, while at the same time giving a comprehensive diagnostic engine analysis of the car for purposes of helping the driver improve their next simulation time. The invention includes a business method which encourages routine engine maintenance through the entertainment value of an interactive racing simulation, plus a combination computer dynamometer and auto racing simulator for accomplishing the method.

2. Description of the Background

There are a variety of commercially available dynamometers for testing auto work output under load. These systems include engine dynamometers that attach directly to the engine, and chassis dynamometers that place stationery flywheels under the drive wheels of the auto. Chassis dynamometers assist with the evaluation of both the engine and vehicle drive-train components. A chassis dynamometer (also called “rolling road”) is capable of simulating driving situations in a controlled environment. These systems generally include a pair of large rollers coupled to a hydraulic dynamometer that provides braking force. The inertia effect of the rollers is calculated to correspond to the moving vehicle weight, and this allows an accurate field test of a vehicle while stationary and yet under full throttle. The operator usually has a hand-held controller to control some of the dynamometer functions while driving the vehicle. The chassis dynamometer has distinct advantages, the most important of which is the possibility of testing complete vehicle performance or engine performance as installed. A wide range of tests are possible, from measuring of power and torque at the wheels to thermodynamic testing and fuel consumption. The sensor measurements help to trace problems with drive-train components during maximum power or torque condition. Thermodynamic testing helps to determine the efficiency of cooling systems. For example, Dyn Systems® sells a chassis dynamometer capable of measuring horsepower & torque, off track tuning and testing, drivability and computer diagnostics, test results of performance parts, speedometer calibration, distributor dial-in, carburetor dial-in, and other types of real time testing & tuning. Automobile service establishments typically buy such dynamometers and profit from them by selling dyno time and associated testing services. It takes very little experience to use a dynamometer, and it can take less than fifteen minutes to mount, test, and output report data. Moreover, the value of dyno testing is well accepted and significant horsepower gains are common during tuning sessions, so customers willingly pay for dyno testing services. A few dynamometer companies are moving toward computer testing and control. For example, one known program called DYNO-MAX® for Windows interfaces with a standard dynamometer for control, data acquisition, and analysis. DYNO-MAX® features on-screen analog and digital gauges, real time graphical displays, and supports complete engine and cell control options. DYNO-MAX® also provides for full test editing such that race simulations or endurance tests can be preprogrammed. When testing is completed, the user is greeted with a report including details on all the engine's specifications.

Owner/operators of the foregoing systems wish to increase demand for dynamometer time, and hence profitability. A novel way of doing this would be to make testing a more entertaining proposition. The present inventor has found a way to integrate racing simulations into the process, thereby introducing an air of competitiveness and encouraging routine engine maintenance in order to stay competitive.

There are a number of existing racing simulation systems. For example, U.S. Pat. No. 5,919,045 to Tagge et al. shows an interactive, vehicle simulator system that displays images to a user sitting in a motion base, and moves the motion base in accordance with the input signals. A controller is in signal communication with the driver's input device, a motion base controller and the image generator, and thereby controls the image generator and the motion base in accordance with the input signals.

U.S. Pat. No. 5,860,862 to Junkin teaches an interactive game based on real time participation. By allowing participants to interact in real time, the emotional enjoyment of the interactive game are greatly enhanced. Various applications inclusive of a NASCAR simulation are disclosed.

Likewise, U.S. Pat. No. 5,662,523 to Yaumaru et al. shows an interactive virtual reality game having a plurality of video displays, a plurality of player control units for controlling the video displays, and position sensors for detecting the positions or the movements of the players.

All three of the above-described systems provide a high entertainment value by making auto racing both interactive and virtual reality. It would be greatly advantageous to provide an even greater entertainment value by making the family car the basis of the simulation. This is possible with the combination auto chassis dynamometer and auto racing simulator described herein. The game value of the simulation encourages the diagnostic testing, thereby promoting routine engine maintenance and generating a comprehensive report with an outline of appropriate repair scenarios for the customer. On the other hand, the diagnostic testing results that are given to the driver include tune-up tips which, if implemented, will prompt the driver to return to try his/her hand at yet another simulation. These incentives for repeated used are taken full advantage of by the business method of the present invention.

### SUMMARY OF THE INVENTION

It is an object of the present invention to provide a forum for safe quarter mile drag racing using one's own car and a dose of virtual reality.

It is another object to provide a simulated drag racing experience as described above which extends beyond a one-time usage, but is continuing in nature with the goal of replicating the competitive process employed on the professional circuit, namely, racing, tuning/repairing for improvement, racing again, and again, etc.

It is another object to provide a business model for capitalizing in multiple respects on the consumer demand for the experience described above.

It is a further object to provide the physical installations for implementing the business method, namely, a combination computer dynamometer and auto racing simulator for encouraging routine engine maintenance by increasing the entertainment value through an interactive racing simulation. The system enables a realistic 3D drag simulation on a diagnostic chassis dynamometer (like pit crews use), wherein the dynamometer controls the simulation to give a vehicle-specific experience.

It is another object to provide a stationery embodiment suitable for use at service stations and auto parts stores, as well as a portable trailer-mounted embodiment which can be transported to NASCAR® and IHRA® (International Hot Rod Association) events everywhere.

It is another object to provide a system as described above that can be implemented using existing dynamometer and PC computer hardware to provide a user-friendly way of standardizing and guiding the dynamometer sampling to determine existing conditions, to take the resulting data and analyze the same, and to generate a report outlining appropriate performance enhancement/repair scenarios for the customer.

It is another object to enable faster data collection, input, analysis, manipulation for consideration of different repair scenarios, and cost analysis for each alternative.

It is another object to subject raw collected dynamometer data to an expert diagnostic system analysis to substantially reduce the requirement for expert assistance, and to eliminate guesswork from the process, and to yield consistent and repeatable results.

It is a further object to provide a standardized, easy to read, comprehensive report containing sufficient information to enable a customer to choose the most cost effective repairs.

It is still another object to increase chassis dynamometer usage by drivers, thereby improving overall maintenance of cars, and improving profitability to the system owner/operators.

In accordance with the above objects, an improved system (inclusive of method and apparatus) for dynamometer testing of a vehicle while providing its driver with an interactive racing simulation experience is disclosed.

The method includes the step of conducting an initial diagnostic simulation with a driver and their car, the simulation being synchronized to the actions of the driver and the characteristics of the car during the simulation. More specifically, the initial diagnostic simulation entails registering a driver onsite by inputting a data record of the driver and their automobile, selecting a standardized (pre-determined) performance profile representative of that make and model of automobile, choosing a race simulation opponent from a central database of driver/auto profiles, and running a real-time diagnostic simulation with the driver in their car on a chassis dynamometer. The simulation experience is synchronized to the actions of the driver and the performance of their car during the simulation. Test data is collected during the simulation and is analyzed to ascertain the engine performance of the test vehicle. Finally, given a proper analysis, a comprehensive driver performance report based on the test data is printed so that the driver can evaluate repair/performance enhancement scenarios. In addition, the driver is given an actual profile for their particular automobile which combines the real-time engine performance results as measured on the chassis dynamometer with certain of the standardized (pre-determined) performance characteristics of the test vehicle such as gross vehicle weight, wind drag, etc.

In accordance with the business model, the repair/performance enhancement scenarios are preferably correlated to a database of advertising sponsors, and in each report a recommended sponsor is identified to provide the necessary goods and services for improving engine performance.

An exemplary apparatus suitable for practicing the above-described method includes a vehicle testing station such as a conventional chassis dynamometer with digital feedback and load control for automatically increasing or decreasing the load applied to the vehicle wheels under test, a programmable test controller connected to the digital feedback unit for collecting real-time performance data, and also connected to the load control assembly for controlling the dynamic load applied to the wheels of the vehicle. In addition, a simulation computer is connected to the programmable test controller, the simulation computer incorporating diagnostic software for storing and analyzing said real-time performance data, plus report generation software for generating the diagnostic report based on the analyzed data. The simulation computer also contains the necessary databases and simulation software for producing the simulation experience. More specifically, the simulation computer contains a first database of standardized (predetermined) performance profiles for most production automobiles, plus a central customer database of driver/auto profiles who have registered and participated in the diagnostic simulation. The customer database includes all actual profiles for participants which are a hybrid of real-time engine performance results as measured on the chassis dynamometer as well as certain standardized (pre-determined) performance characteristics of their vehicle which cannot be measured on the dynamometer (gross vehicle weight, wind drag, etc.). The simulation computer also contains executable simulation software which provides the driver (while in their car on the chassis dynamometer) with a visual simulation experience synchronized to the actions of the driver and the real-time performance of their car during the simulation.

By virtue of the diagnostic software described above, test data is collected during the simulation and is analyzed to ascertain the engine performance of the test vehicle. Finally, given a proper analysis, the test report software generates a comprehensive driver performance report so that the driver can evaluate repair/performance enhancement scenarios. The participating drivers also receive a coupon for a follow-up diagnostic simulation to race their car again after making the recommended improvements.

After participating, the driver is also given their actual test profile which incorporates real-time engine performance results plus standardized performance characteristics of their vehicle. The test profile allows the driver to compete in subsequent non-diagnostic simulations using a personal computer or arcade-style racing simulator, in either case enjoying a realistic drag race simulation which reflects their own car's aesthetics and performance in every respect. By loading their actual test profile into a consumer version of the simulation software running on a home personal computer or arcade-style racing simulator, the driver can simulate races driving their own cars at will.

The simulation computer is connected to a central monitoring station via a wide area network so that actual driver/vehicle profiles can be maintained in a central database accessible via the internet, so that drivers can race interactively online, selecting their competition (such as relatives, neighbors and friends) and simulating races on their personal computers. Sponsor/advertiser profiles and web sites will be likewise available so that drivers can research repair options and purchase parts online. There are also discussion forums where pro's share their secrets.

The foregoing system increases the entertainment value of diagnostic testing by means of the interactive racing simulation. The system standardizes and guides dynamometer sampling to determine existing conditions, automates the data collection and analysis phase, and generates a comprehensive report outlining appropriate performance enhancement/repair scenarios for the customer. An everyday driver can drive up to a station in their station wagon with the kids in the back, tell the operator that he wants to race his neighbor in his Beetle . . . the lights on the Christmas tree go down, and there he is roaring along at 200 mph with the kids screaming to catch up, yet they are all safe and standing still. At the end of each race the driver meets briefly with a “pit boss” operator who hands them a complete diagnostic performance report and explains driving errors (premature shifting, etc.), points out engine trouble, and recommends performance parts to make the car faster. The driver gets his test profile for simulated races at home. Any registered user with a profile can race anyone else with a profile, online, anytime!

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a perspective diagram showing the major components of the preferred Dynamometer/Racing Simulator System 2.

FIG. 2 is a sample plot of raw test data logged by test controller 10 during a standard acceleration test.

FIG. 3 is a screen print of an exemplary user interface as viewed by the service technician prior to conducting a simulation.

FIG. 4 is an outline of an exemplary performance report, with graph, that is generated by the present invention.

FIG. 5 is a flow-chart illustration of the method of operating the Dynamometer/Racing Simulator System according to the present invention.

FIG. 6 is an example of the actual video as displayed on the driver video display 13.

### DETAILED DESCRIPTION OF THE PREFERRED EMBODIMENTS

The present invention is a Dynamometer/Racing Simulator System inclusive of method and apparatus for dynamometer testing of vehicles while providing drivers with an interactive racing simulation experience. The Dynamometer/Racing Simulator System is a hybrid: it is one part auto service tool to speed the collection, sorting and analysis of data to isolate problems in the engine and to prioritize performance improvement options for the automobile; and it is another part virtual reality arcade game that gives a realistic interactive racing simulation with lasting entertainment value to encourage routine auto maintenance and repeat participation. In this way the Dynamometer/Racing Simulator System replicates the thrill of the entire competitive process employed on the professional circuit, namely, racing, tuning/repairing for improvement, and racing again, and again.

1. The Dynamometer/Racing Simulator System

The Dynamometer/Racing Simulator System includes both hardware and software components.

A. Hardware

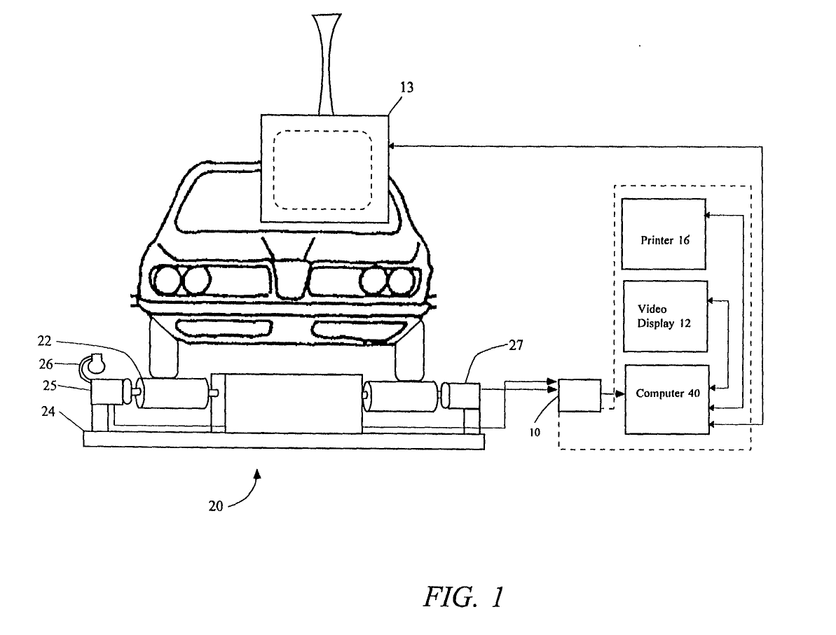

FIG. 1 shows the major hardware components of the Dynamometer/Racing Simulator System 2, inclusive of a testing station 20 which is a conventional chassis dynamometer, the programmable test controller 10 connected to a simulation computer 40 (inclusive of mouse and keyboard . . . not shown), an associated technician display terminal 12, driver simulation display 13, and a printer 16 for printing test reports in hard copy. The simulation computer 40, video display 12 and keyboard 14 may be housed in a single physical unit which is connected by standard cables to both the test controller 10 and testing station 20.

The testing station 20 is preferably a conventional 750 horsepower chassis dynamometer with digital feedback and load control for automatically increasing or decreasing the load applied to the vehicle wheels under test. There are a number of suitable commercial dynamometers that will suffice, inclusive of a 750 hp model produced by Precision Dynamometer, Inc. 1870 Enterprise Parkway, Twinsburg, Ohio. Dyn Systems® also sells a suitable chassis dynamometer, as does Land & Sea, Inc. of North Salem, N.H. Testing station 20 will typically incorporate roller-mounting(s) 22 supported by heavy duty floor stands 24 for rotatably seating 10 the wheels of the test vehicle during stationery testing. Each roller mounting 22 may comprise a single roller under both wheels of the test vehicle, or tandem (side-by-side) rollers as shown. In accordance with typical dynamometers, only one axle of the vehicle is supported by roller mounting(s) 20, and this is generally sufficient to accommodate both rear or front wheel drive vehicles (which may be driven or backed into the test station, respectively). However, it should be noted that it is possible to incorporate four independent roller-mountings 22 for individual testing of each wheel of the test vehicle, and this is better suited to four-wheel drive vehicles. In any of these cases, each roller-mounting 22 is equipped with a braking mechanism that may be a hydraulic pump unit 25 including pressure control valve 26 also connected to test controller 10 for automatically increasing or decreasing the load applied to the vehicle wheels under test. Each roller-mounting 22 is also provides feedback via a servo-feedback unit 27 connected to test controller 10 for providing digital feedback data.

The test controller 10 controls the dynamometer in accordance with a selected pre-programmed test procedure. In addition, the test controller 10 presents a user interface to the technician for selecting the test sequence, for controlling the test station 20, and for logging the test vehicle's performance. Most all existing commercial dynamometers are equipped with onboard programable logic controllers from, e.g., Allen-Bradley Corp., and most any of these will serve as test controller 10 so long as an RS-232 output connector is provided. Alternatively, a laptop computer or even a second desktop computer may be used for this purpose. The test controller 10 coordinates operation of the test station 20 by controlling the rollers while taking measurements of torque and power output and engine speed at predetermined points. Test controllers of the type that are provided with most commercially-available dynamometers are pre-programmed with a variety of test procedures, including hill profiles, stop-and-go, etc. The present invention is intended to simulate an open ¼ mile drag race, and this is the preferred test procedure to be employed here (although others may be used). The test controller 10 controls each pressure control valve 26 in accordance with the selected pre-programmed test procedure to allow the driver to increase engine speed over a predetermined range, typically from idle to maximum RPM. Engine output power is measured by servo-feedback units 27 so that during each run the servo-feedback units 27 pass real-time test data to test controller 10.

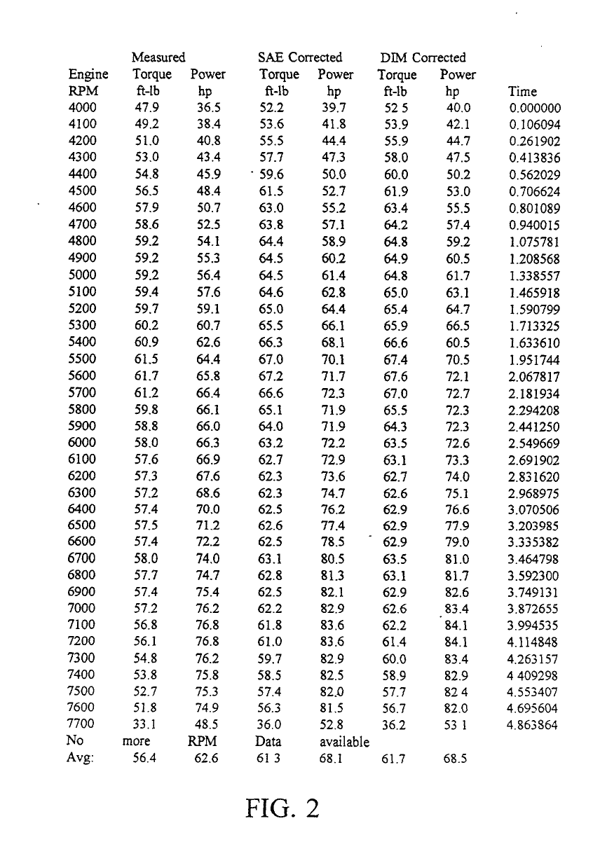

FIG. 2 is a sample plot of the raw test data logged by test controller 10 during a standard acceleration test. The data reflects torque, power and rpm measurements taken at approximately 1/10 th second intervals between 4000 and 8000 rpms. Measured, corrected SAE, and corrected DIM data is provided. The torque as applied to the vehicle under test is measured by measuring the pump unit 25 output pressure. The pump output pressure signal is passed to the computer 10. The wheel rotation speed is measured by the servo-feedback units 27 mounted at each roller-mounting 22, and this transmits a speed signal to the test controller 10. Using this configuration allows control over the rotational speed of the wheels of the test vehicle as well as the load applied thereto.

Controller 10 is connected by RS-232 serial data connection to simulation computer 40. The RS-232 connection allows the real-time test data gathered by test controller 10 to be communicated to simulation computer 40 and stored thereon. All raw test data logged at the test controller 10 is transmitted directly to the simulation computer 40 for four reasons. First, the simulation computer 40 runs a multi-media race simulation (to be described) for the owner/driver of the test vehicle. Second, the simulation computer 40 synchronizes control over the test station 20 in accordance with the ongoing race simulation. Third, the simulation computer 40 runs an analysis program that plots the resulting data and prints a user-friendly report for the owner of the vehicle. Finally, the simulation computer 40 prepares a vehicle profile from the logged data which is transmitted post-testing by satellite to a central vehicle library. The simulation computer 40 is a conventional computer workstation, inclusive of operating system, on which resides the software components of the present invention. The computer workstation may be, for example, a conventional personal computer with standard internal components, e.g., an Intel Pentium microprocessor with peripheral chipset mounted on an appropriate motherboard. Of course, other more or less powerful computer systems can be used, but it is suggested that minimum system performance is realized with a 266 Mhz CPU processor with 32 Mb of RAM. Approximately 20 Mb of storage is required, and this may be in the form of conventional hard disk storage.

The technician interface is preferably a conventional color video display 12, and standard input devices including a keyboard and mouse are provided. The operating system is preferably Windows 2000 or a like system.

An additional video output port is connected to a driver display 18 for displaying a simulation sequence (to be described) to the driver of the test vehicle. The driver display 18 may be a conventional LCD or CRT display that is suspended in front of the car, or it may be a conventional LCD digital projector positioned to project the simulation sequence onto a wall or projection screen located in front of the vehicle. Alternatively, driver display 18 may be a set of conventional virtual reality glasses worn by the driver, or a dash-mounted projector for projecting the simulation up onto the windshield of the vehicle.

The present system contemplates both a stationery embodiment suitable for use at service stations and auto parts stores, as well as a portable trailer-mounted embodiment which can be transported to NASCAR® and IHRA® (International Hot Rod Association) events everywhere. In the stationery embodiment, the testing station 20 is permanently installed in, for example, a service station bay, the conventional chassis dynamometer being anchored in a conventional manner with programmable test controller 10, simulation computer 40 (inclusive of mouse and keyboard), printer 16, and associated technician display terminal 12 being located proximate thereto for ease of operation. The driver simulation display 13 may be suspended from the ceiling or attached to a forward wall for viewing by participating drivers. In the transportable embodiment, the testing station 20 is mounted on a conventional transport trailer with chassis dynamometer being anchored thereto. In this case, a low-rider flatbed trailer with air-damped shock absorbers is recommended so that the trailer and dynamometer can be lowered toward the ground at any desired test site, and conventional auto ramps are used to give drivers easy drive-on access to the testing station 20. In the latter case the trailer is preferably enclosed so that the driver simulation display 13 can again be suspended from the ceiling or attached to a forward wall for viewing by participating drivers. A conventional exhaust fan will generally be necessary to clear emissions. All of the programmable test controller 10, simulation computer 40 (inclusive of mouse and keyboard), printer 16, and associated technician display terminal 12 are anchored to a movable console located inside the trailer.

B. Software Components

The simulation computer contains the necessary customer database, simulation software for producing the simulation experience, and diagnostic software for producing tangible test results.

The resident databases include a standards database of standardized (pre-determined) performance profiles for most production automobiles, plus a central customer database of driver/auto profiles who have registered and previously participated in the diagnostic simulation. This customer database includes all actual test profiles for past participants, each of which is a hybrid of their real-time engine performance results as measured on the chassis dynamometer supplemented by the standardized performance characteristics which cannot be measured on the dynamometer but are taken instead from the standards database.

As stated above, the real time drag race simulation is effected by an executable multi-media race simulation program resident on the simulation computer 40 which provides the driver (while in their car on the chassis dynamometer) with a visual simulation experience synchronized to the actions of the driver and the real-time performance of their car during the simulation. The visual simulation is rendered for the benefit of the driver on driver display 18. This software must be capable of generating a realistic 3D drag race simulation on a quarter mile track based on two profile records, one being the participating driver's and the other being either a standard auto profile from the standard library, or a second test profile from the customer database. Both selected records include standardized (predetermined) performance characteristics of the competing vehicles which cannot be measured on the dynamometer (size, color, gross vehicle weight, wind drag, etc.). If an actual test profile is selected for competition, it will include another driver's name and registration information, plus actual test results from their previous diagnostic simulation. This allows the participating driver to select his opponent by name, vehicle type, etc. This also provides the ability to “race” friends or specific vehicle types, greatly increasing the entertainment value of the system.

Each test profile is based on the power and torque curves derived from previously logged data, as well as detailed engine specifications. The primary goal of each profile is to reflect performance patterns so that predictive changes in the engine components will affect the simulation results. This requires translation of the logged data into a predictive engine model, and yet a simplified model capable of regenerating performance curves in real time for use in subsequent simulations. A number of engine performance models exist, and the presently-preferred alternative uses artificial intelligence for pattern recognition to determine exactly what each engine has in common with others. This way, patterns within the data can be precisely measured, recorded, and made a part of the profile. Rapid Line Industries located at 455 North Ottawa Street in Joliet, Ill. offers a suitable artificial intelligence profiling service for rendering the profiles, and preexisting profiles can be purchased. The use of performance profiles in this manner gives participating drivers the flexibility to choose their competition, the profiles being selected and keyed into the simulation computer 40 by the pit boss prior to conducting the diagnostic simulation.

Once both profile records are selected and loaded, the drag race simulation must accept a real time input from the test controller (through the RS-232 connection) which transmits torque, power and rpm measurements taken at approximately 1/10th second intervals between approximately 4000 and 8000 rpms. The 3D drag race simulation software uses at least the real time rpm input to generate the simulation for the participating driver and his vehicle while racing on the Dynamometer/Racing Simulator System 2.

After the participating driver's diagnostic simulation, his standard auto profile is supplemented with actual test results from the diagnostic simulation, the “hybrid” record is rounded out with his registration information, he is accorded a registration number, and the record is stored in the customer database.

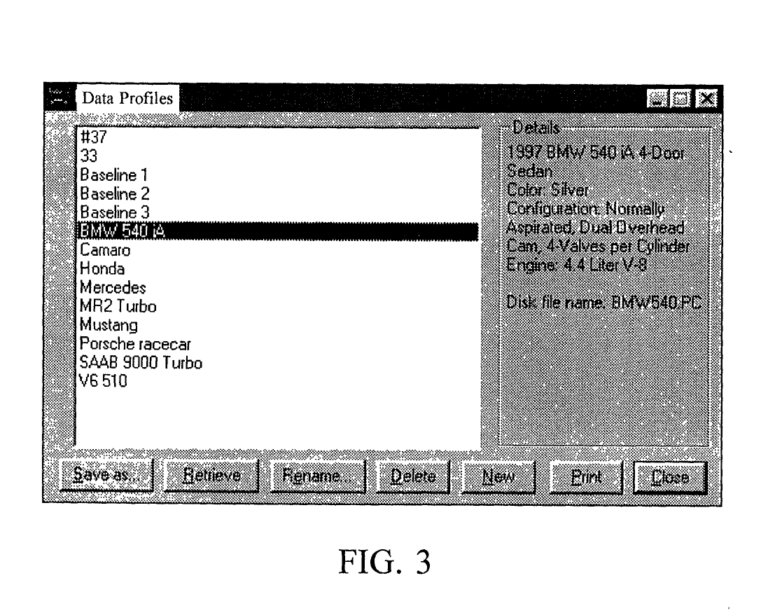

FIG. 3 is a screen print of an exemplary user interface as viewed by the service technician prior to conducting a simulation. The screen provides a list of available data profiles as well as options for sorting and displaying the profiles by make and model and/or individual owner.

The presently-preferred 3D drag race simulation software is the IHRA Drag Racing™ program from Bethesda Softworks, Maryland, which allows a wide selection of IHRA-sanctioned tracks, both ¼ and 1/18 mile racing, and in which the simulation engine is designed to run based on the pre-determined vehicle profile records as stated above in which 70 vehicle components are customized for any selected car, including suspension, transmission, tires, aerodynamics, and electronics. In this manner, the IHRA Drag Racing simulation engine creates a realistic simulation of engine dynamics including fuels, cams, blowers, and nitrous injection. For purposes of the present invention, the consumer version of the 3D drag race simulation is modified slightly to accept real time input from the test controller through the RS-232 connection. Specifically, the consumer version of the IHRA Drag Racing™ software (and most other simulation applications) is designed to accept an accelerator input from a computer keyboard or video game controller. The consumer version may be readily modified to accept the rpm data from the test controller through the RS-232 connection in place of a standard keyboard or video game controller.

Preferably, all simulation computers 20 at a given test station 2 are networked, and all test stations 2 are connected in a conventional wide area network to a central monitoring station. The connecting backbone is preferably a satellite network to allow mobility, albeit standard ATM or internet backbone may also be used. Every time that an auto is tested in the present system the logged performance data is transmitted by network or satellite link to the central monitoring station, and the customer profile is generated and stored for reuse in subsequent simulations.

In addition to the simulation software, the simulation computer 40 incorporates diagnostic software for storing and analyzing said real-time performance data, plus report generation software for generating the diagnostic report based on the analyzed data. By virtue of the diagnostic software, real time test data is collected during the simulation and is analyzed to ascertain the engine performance of the test vehicle. Given a proper analysis, the test report software generates a comprehensive driver performance report so that the driver can evaluate repair/performance enhancement scenarios. Suitable diagnostic and report generation software is readily available from a number of companies, and in fact can be purchased in conjunction with the chassis dynamometer. Specifically, Land & Sea, Inc. publishes their DYNO-MAX® for Windows software which interfaces with any standard dynamometer for control, data acquisition, and analysis. DYNO-MAX® features on-screen analog and digital gauges, real time graphical displays, and is capable of outputting a comprehensive diagnostic report to a standard printer. Likewise, Precision Dynamometer, Inc. sells a comparable diagnostic and report generation software package with their dynamometers.

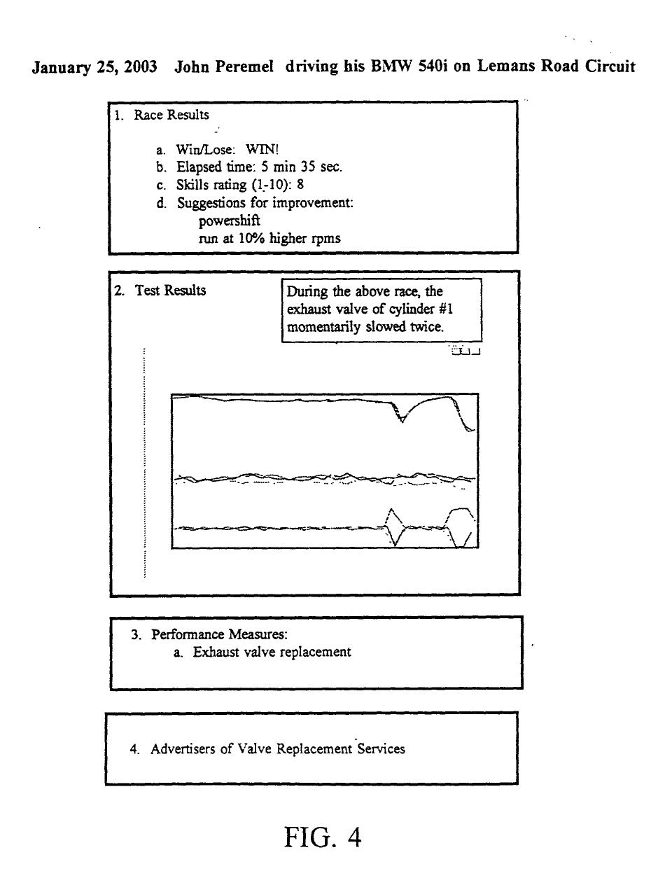

FIG. 4 is an outline of an exemplary performance report, with graph, that is divided into the following sections.

1. Race Results: elapsed time for the race, win/lose, driver skills rating and suggestions for improvement.

2. Test Results: inclusive of graphical analysis of raw test data logged by test controller 10 as shown in FIG. 2, comparative test results relative to the opponent and on average. Here, the graphical analysis belies a sticky exhaust valve (cylinder #1), and this is pointed out in the report and is explained in plain language to the driver.

3. Performance Measures: a prioritized list of available performance enhancements that could be incorporated to improve the test results. This includes such minor fixes as a tune-up, new plugs, or a switch to synthetic oil, to major enhancements such as a new engine. Here, a new valve replacement is suggested.

The foregoing software increases the entertainment value of diagnostic testing by facilitating the interactive racing simulation during diagnostic testing. The system standardizes and guides dynamometer sampling to determine existing conditions, automates the data collection and analysis phase, and generates a comprehensive report outlining appropriate performance enhancement/repair scenarios for the customer.

2. Dynamometer/Racing Simulator System Business Method

Given the above-described profiling technique for real-time simulation, the business method of the present invention promotes continuing interest and repeat usage beginning with the initial diagnostic simulation and afterward. This is done by operating each test site of the Dynamometer/Racing Simulator System according to specific guidelines to properly present the diagnostic feedback and the hope of performance improvement and return business. In accordance with a broader business model and method, further simulations can be run remotely on personal computers and/or arcade-style games, and a racing web portal is provided to further increase attention and interest in participation.

A. The Diagnostic Simulation

Any everyday driver can drive up to a Dynamometer/Racing Simulator station at either a stationery installation at a nearby service station, or to a portable trailer-mounted embodiment at an auto-racing event. The driver pays an initial registration fee, drives his vehicle onto the Dynamometer/Racing Simulator System 2 (with the kids in the back) and tells the pit boss operator that he wants to race his neighbor in his Volkswagon Beetle. The operator initiates the diagnostic simulation from the simulation computer 40, the lights on the Christmas tree go down, and there he is roaring along at 200 mph with the kids screaming to catch up, yet everyone is completely safe and standing still.

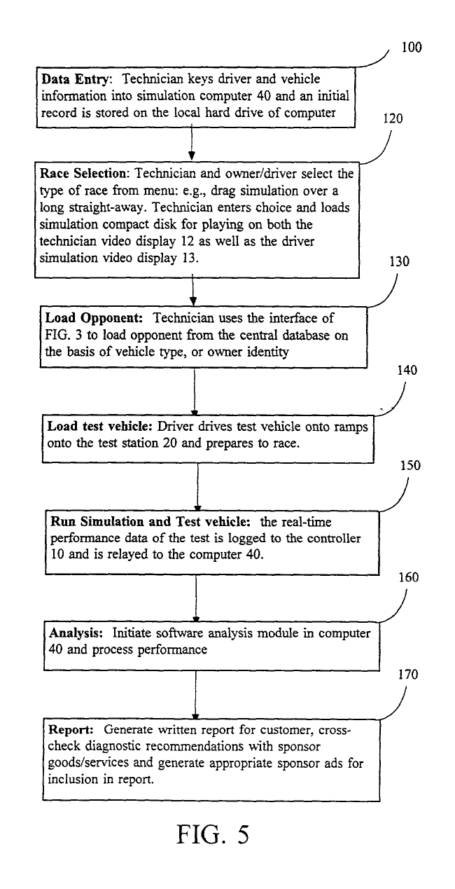

FIG. 5 is a flow-chart illustration of the method of operating the Dynamometer/Racing Simulator System at each test site according to the present invention.

When an individual has decided that they want to test their vehicle on the Dynamometer/Racing Simulator System 2 of the present invention, they register onsite by providing an account of themselves and full details of their automobile. At step 100, the technician keys this information into simulation computer 40 and an initial record is stored on the local hard drive of computer 40. At step 120 the technician and owner/driver establish the details of the race simulation. This is accomplished by selecting the type of race in which to participate. There may be various potential choices. However, the present embodiment employs a quarter-mile drag simulation over a long straight-away to test acceleration of large-bloc performance engines. All of the visual and audio cues are specific to that type of race, e.g., lights going down on the starting Christmas tree. The technician selects the simulation software on computer 40 for playing on driver simulation video display 13.

Once the simulation type has been selected, the technician and owner/driver establish the race opponent. As shown at step 130, the technician uses the interface of FIG. 3 to load an opponent from the central database. The opponent can be chosen on the basis of vehicle type, or on the basis of an individual's name/identity. In this regard, once a national customer database of driver/auto profiles as described above will be accumulated so that drivers are free to compete with friends, relatives, and adversaries. If, on the other hand, the owner/driver chooses to test his car against a specific auto, the pit boss technician can load a profile for that auto as shown in FIG. 3 (a BMW 540). The profile is selected at the local level but the profile files are centrally maintained and the corresponding BMW540.pc file must be downloaded for use from the central monitoring station. With both competing profiles and the race type selected, the simulation/testing is ready to begin.

At step 140, the owner/driver drives his test vehicle up the ramps onto the test station 20 and prepares to race.

At step 150, the simulation/test is initiated and data is collected.

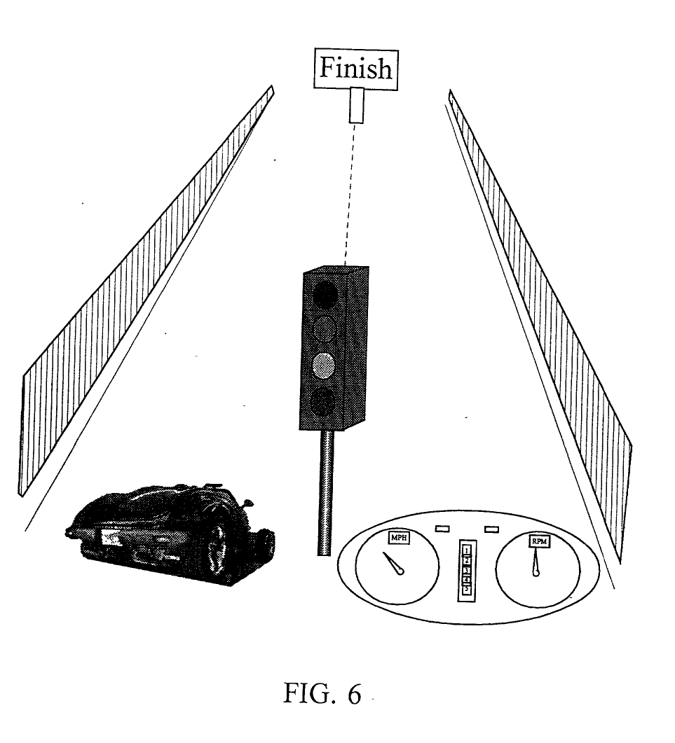

FIG. 6 is an example of the actual video as displayed on the driver video display 13. The driver is given a full complement of race gauges on one portion of the display, and the majority of the display is dedicated to projecting a realistic 3-D rendering of the passing terrain. Of course, the simulation is synchronized by computer 40 to the rpm output from the servo-feedback units 27 mounted at each roller-mounting 22. Thus, all shifting, acceleration, and slowing is registered by computer 40 and is used to control the actual display image shown on display 13. The owner/driver gets the distinct and exhilarating sensation of participating in a drag race.

At the same time, and referring back to step 150 of FIG. 5, the real-time performance data of the test is logged to the controller 10 and is relayed to the computer 40. As soon as the race/testing is completed, an software analysis module is initiated in computer 40 and the performance data is processed and output in the form of a comprehensive driver performance report. Although the results are of substance, the report is also designed as an advertising medium and the method of the present invention leaves room for advertising sponsorships. A database of advertising sponsors, their products, and advertisements therefor is maintained at the central monitoring station. Whenever a test isolates a problem and necessitates repair or replacement of a part, an advertisement for an appropriate sponsor that can sell the necessary part and/or services to the driver is printed directly in the report. This gives the sponsor targeted exposure and ensures a high level of convenience for the driver.

Referring back to FIG. 5, at step 170 the simulation/test report is generated and given to the driver. At the same time a customer record inclusive of actual test profile is generated for the immediate driver and is transmitted back to the central monitoring station for entry into the national database of driver/auto profiles.

Use of the above-described method of operating each test site of the Dynamometer/Racing Simulator System affords faster data collection, input and analysis by the user/engineer. Moreover, it allows the user to print a standardized, easy to read, comprehensive report for their customers by which repairs can be timed with pinpoint cost-effectiveness. The report can be easily understood by lay persons.

B. Diagnostic Feedback

Proper diagnostic feedback is important to promote repeat business. At the end of the race the driver meets briefly with a “pit boss” operator who hands them the complete diagnostic performance report and explains driving errors (premature shifting, etc.), points out engine trouble, and recommends performance parts to make the car faster. The driver is also given his customer record inclusive of actual test profile on floppy disk or CD-ROM for simulated races at home. Optionally, the driver can purchase the standard home version of the IHRA Drag Racing™ program from Bethesda Softworks. This way, any registered user with a profile can race anyone else with a profile, online, anytime! The above-described method is intended to replicate the competitive process employed on the professional circuit, namely, racing, tuning/repairing for improvement, racing again, and again, etc. It is envisioned that the driver will take the advice of the pit boss and repair engine trouble and install performance parts to make the car faster. Thus, in addition to the diagnostic report and personal profile, the driver is also given a coupon for a follow-up diagnostic simulation to race their car again after making the recommended improvements.

The benefits of the Dynamometer/Racing Simulator System over conventional dynamometers currently utilized within the industry are as follows:

more uniform data collection and input;

repairs can be timed with pinpoint accuracy;

analysis can consider alternative hypothetical repair options;

a standardized, easy to read, comprehensive report to the user;

an expert diagnostic software program for instant analysis;

increased chassis dynamometer usage by drivers results in better overall maintenance of cars, more profitability to the system owner/operators, and more timely and constructive repair efforts rather than total loss of vehicle.

C. Racing Web Portal

The broader business model/method of the present invention relies on a national network of test sites wherein each simulation computer 40 is connected to a central monitoring station via a wide area network. A racing web portal is maintained on an internet-enabled server at the central monitoring site. The web portal provides an important revenue source and promotes interest and participation in the diagnostic simulations. Three particular three services are offered on the web portal.

First, an online interactive racing forum is provided, and all standard and customer profiles are made available to the public so that registered users can race at home using their own computers. IHRA Drag Racing™ is web-enabled as is to facilitate interactive play, and the program is loaded onto the central server for distributed public access. Any registered user can retrieve their own profile from the server or the disk which they were given following their diagnostic simulation, and they can select any other registered user and/or vehicle for racing online. A nominal fee is charged per race, and race statistics are kept at the server to encourage competition. Second, a discussion forum is maintained to facilitate user-to-user communication about race strategies and tactics, as well as maintenance and repair tips. Online chat rooms with professional drivers generate further interest and participation.

Third, advertising space is reserved for affiliate and sponsor advertising. Consumers are provided with research material and direct links to affiliate and sponsor web sites so that they can research repair options and purchase repair and performance parts online. Commissions are charged.

The business model as described above propagates the simulated drag racing experience beyond a one-time usage and makes it lasting in nature, more akin to the professional circuit, namely, racing, analyzing, researching, tuning/repairing for improvement, racing again, and again, etc. The business model provides multiple revenue streams to capitalize on the consumer demand for the experience.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth herein.

I claim:

1. A method for dynamometer testing of a vehicle while providing its driver with an interactive racing simulation experience, comprising:
registering a driver onsite by inputting a record of the driver and details of their automobile;
driving said automobile onto a dynamometer;
choosing a race simulation opponent from a central database of driver/auto profiles;
generating a race simulation, the simulation being synchronized to feedback from said dynamometer during the simulation;
collecting test data from said dynamometer and analyzing said data to ascertain the engine performance of said test vehicle;
providing said driver with a comprehensive driver performance report based on said test data.

2. The method for dynamometer testing of a vehicle according to claim 1, further comprising the step of analyzing said test data to articulate specific performance improvement measures to said driver in said comprehensive driver performance report.

3. The method for dynamometer testing of a vehicle according to claim 2, further comprising the step of comparing said driver performance report with a database of advertising sponsors capable of providing the specific performance improvement measures and recommending a sponsor to said driver.

4. A combination dynamometer and racing simulator system, comprising:
a chassis dynamometer having at least one roller-mounting for rotatably seating the wheels of a test vehicle during stationery testing, said vehicle testing station also including a digital feedback unit connected to said roller-mountings for providing digital feedback data, and a load control assembly for automatically increasing or decreasing the load applied to the test vehicle wheels;
a programmable test controller connected to said digital feedback unit for collecting test data therefrom, and connected to said load control assembly for controlling the dynamic load applied to the test vehicle wheels;
a simulation computer connected to said programmable test controller, said simulation computer incorporating diagnostic software for analyzing said data, simulation software for running a synchronized race simulation in accordance with said data, and report generation software for generating a user-friendly diagnostic report based on the analyzed data;
a driver simulation display terminal for displaying said synchronized race simulation to the driver of a test vehicle.

5. The combination dynamometer and racing simulator system according to claim 4, wherein said simulation software reads a driver profile of the participant's car, allows selection of a profile for a competing car, and then runs a synchronized race simulation using said profiles and in accordance with said test data.

6. The combination dynamometer and racing simulator system according to claim 5, wherein said simulation computer is connected to a central monitoring station via a wide area network.

7. The combination dynamometer and racing simulator system according to claim 6, wherein said central monitoring station maintains a database of profiles for drivers and their vehicles that have used the system.

8. The combination dynamometer and racing simulator system according to claim 7, wherein said central monitoring station also maintains a database of advertisers.

9. The combination dynamometer and racing simulator system according to claim 7, wherein each profile record initially comprises a set of standard digital engine performance specifications for an identified car model.

10. The combination dynamometer and racing simulator system according to claim 9, wherein said simulation computer contains a firs t library of profile records of standard performance specifications for a plurality of identified car models.

11. The combination dynamometer and racing simulator system according to claim 10, wherein said simulation computer builds a second library of customer profile records associated with each participating driver, each customer profile record further comprising a subset of said standard performance specifications for said driver's identified car model supplemented by actual collected diagnostic data.

12. The combination dynamometer and racing simulator system according to claim 4, further comprising a trailer for transportable mounting of said chassis dynamometer.

13. A method of operating a dynamometer and racing simulator, comprising the steps of:
conducting diagnostic simulations for drivers and their cars at a test site using a chassis dynamometer in communication with a simulation computer, said simulation computer incorporating diagnostic software for analyzing said cars, and said simulation computer incorporating simulation software for running a synchronized race simulation to entertain said drivers during analysis, whereupon a diagnostic profile is associated with each driver and their car based upon their diagnostic simulation; and
a web portal including a central web server for maintaining a library of said diagnostic profiles to facilitate competitive racing simulations from a remote personal computer.
